(19) United States
(12) Patent Application Publication
(10) Pub. No.: US 2019/0213614 A1
(43) Pub. Date: Jul. 11, 2019

(54) INFORMATION INTEGRATION DISPLAYING PLATFORM AND DISPLAYING METHOD THEREOF

(71) Applicant: NATIONAL CHIN-YI UNIVERSITY OF TECHNOLOGY, Taichung City (TW)

(72) Inventor: SHIH KUANG WU, Taichung City (TW)

(21) Appl. No.: 15/863,304

(22) Filed: Jan. 5, 2018

(51) Int. Cl. G06Q 30/02

(52) U.S. Cl. CPC G06Q 30/0205; G06F 17/30241

(57) ABSTRACT

An information integration displaying platform includes an interface module; a store information module provided with a plurality of store information; a requirement module providing requirement options including a commercial area requirement, a turnover requirement, a search range requirement and a store type requirement; an operation module; and an integration processing module screening the store information according to the options of the commercial area requirement, the turnover requirement, the search range requirement and the store type requirement selected by the user, so as to analyze to acquire an integration analyzing result which is graphically displayed at the interface module. Therefore, the market competitiveness of a store is acquired for a potential store owner to determine the marketing strategy and reduce the failure of opening a store.

### BACKGROUND OF THE INVENTION

### 1. Field of the Invention

The present invention relates to information processing fields, and more particularly, to an information integration displaying platform and displaying method thereof.

### 2. Description of the Related Art

In recent years, the competition in commodity retailing market becomes more and more intense. For facing the varying consumer environment, many retailing enterprises adapt a running mode of chain stores, such as convenient stores, hyper markets, furniture stores, or food related shops. With commercial area analysis and market investment, the foundation for entering the retailing market is efficiently improved. Therefore, proper commercial area analysis is a key factor of a success enterprise.

However, reliable conventional commercial area and competitiveness assessments need to be carried out by practical field research. Also, field research is unable to neither understand the actual running status of other stores in depth, nor accurately determine if the enterprise has a matching competitiveness in possession. As a result, starting a store without conducting an accurate market investigation may easily cause the failure of the business.

In addition, regarding the commodities, physical stores are able to provide substantial product sample for potential consumers. In other words, online retailers are only capable of providing pictures, images, and text sample of products as references for potential consumers, failing to offer a physical purchasing experience.

As for furniture industry, when purchasing furniture in a physical store, a potential consumer is only able to choose the proper style of products based on the size of the furniture or memory of applicable space at home, failing to accurately compare the furniture and the real space for furniture disposition.

Furthermore, when purchasing furniture online, a potential consumer is only able to choose the product based on the pictures or models provided by the website, failing to accurately compare the furniture and the real space for furniture disposition as well. When determining with relatively limited information, the uncertainty for furniture purchasing remains for ether physical or online stores, so as to hinder the cognition and buying desire of the consumer upon the commodities.

Therefore, it is desirable to resolve the issues above by conducting efficient market competitiveness analysis and improving the purchasing mode of consumers.

### SUMMARY OF THE INVENTION

For improving the issues above, an embodiment discloses an information integration displaying platform and displaying method thereof, which conducts a commercial area competition analysis according to the selected requirements by use of the integration processing module, so as to understand the strength and weakness of the competitors based on the graphical result of integrated analysis. Therefore, by acquiring the market competitiveness according to the integrated analysis result, a marketing strategy basis of commodities is provided for a future store owner, thereby reducing the risk of business failure.

An information integration displaying platform in accordance with an embodiment of the present invention is provided, comprising:

an interface module;

a store information module signally connected with the interface module and provided with a plurality of store information;

a requirement module signally connected with the interface module and displayed at the interface module, the requirement module providing requirement options including a commercial area requirement, a turnover requirement, and a search range requirement;

an operation module signally connected with the requirement module, such that a user selects at least one option among the commercial area requirement, the turnover requirement, and the search range requirement through the operation module; and

an integration processing module signally connected with the store information module, the requirement module, and the interface module, the integration processing module screening the store information according to the at least one option among the commercial area requirement, the turnover requirement, and the search range requirement selected by the user, so as to analyze to acquire an integration analyzing result which is displayed at the interface module in a graphical form.

In an embodiment of the present invention, the present invention further includes an image module signally connected with the store information module and the integration processing module. The image module is provided with a map information, wherein the store information and the integration analyzing result is graphically displayed on the map information.

In an embodiment of the present invention, the present invention further includes a product module signally connected with the interface module for storing a plurality of product signals and a product information corresponding to each product signal. The product signals and the product information are displayed at the interface module.

In an embodiment of the present invention, the present invention further includes a photograph module signally connected with the interface module, the product module, and the operation module. The photograph module photographs the real environment to produce a space image signal, which is displayed at the interface module. The operation module is applied for selecting product signals to be placed in the space image signal.

In an embodiment of the present invention, the present invention provides an information integration displaying method, including:

selecting a commercial area requirement, a turnover requirement, a search range requirement, and a store type requirement according to user demand;

screening the plurality of store information according to the selected options of the commercial area requirement, the turnover requirement, the search range requirement, and the store type requirement to analyze and acquire an integration analyzing result; and

displaying the integration analyzing result on a map information in a graphical form, so as to acquire a competition level of a store within a scope corresponding to the search range requirement.

With such configuration, the present invention carries out the commercial area competition analysis by use of the integration processing module, so as to clearly identify the strength and weakness of the competitors. Accordingly, the user is able to understand the competitiveness of the store in the market through the integration analyzing result, so as to acquire a marketing strategy basis of products, thereby reducing the risk of business failure.

Also, by displaying the integration analyzing result with colorful and graphical form on the map information, the user is allowed to understand the current competition status in the certain commercial area, which is considered as a basis of determination about whether or not the user will benefit from opening a new store.

Furthermore, with the product module and the photograph module, the present invention is able to display products in a simulation form and provide a combination of the products and the real environment. Therefore, for a potential consumer, the uncertainty upon the products is lowered, and a physical purchasing experience is provided.

### BRIEF DESCRIPTION OF THE DRAWINGS

FIG. 1 is a schematic view illustrating the system structure in accordance with an embodiment of the present invention.

FIG. 2 is another schematic view illustrating the requirement module displayed at the interface module.

FIG. 3 is another schematic view illustrating the integration analyzing result.

FIG. 4 is another schematic view illustrating the photograph module photographing a real environment to produce an image signal which is displayed at the interface module.

FIG. 5 is another schematic view illustrating the product signal placed in the space image signal.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

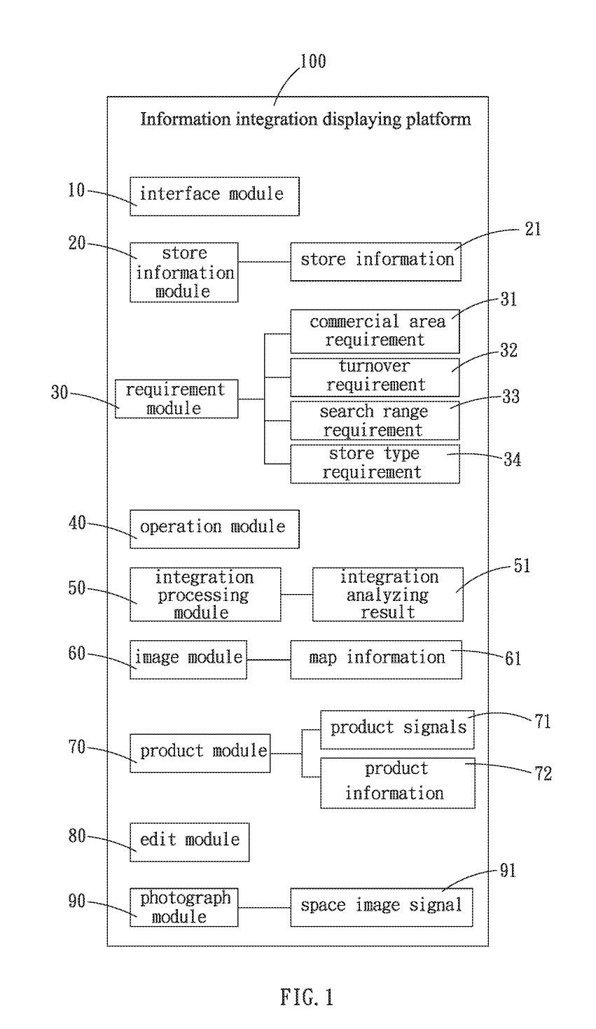

Referring to FIG. 1 to FIG. 5, an information integration displaying platform 100 in accordance with an embodiment of the present invention is provided. The information integration displaying platform 100 is applied for being used by a plurality of users, respectively, wherein a terminal machine is connected with a displaying monitor. The terminal machine is allowed to be a tablet, a portable device such as an intelligent phone, or a non-portable device such as a personal computer. When the terminal machine is a non-portable device, the displaying monitor refers to a computer monitor, and the operation measure of the information integration displaying platform 100 is allowed to be a connection software. When the terminal device is a portable device, the displaying monitor refers to a touch panel, and the operation measure of the information integration displaying platform 100 is allowed to be an application program (APP). In an embodiment of the present invention, the information integration displaying platform 100 comprises an interface module 10, a store information module 20, a requirement module 30, an operation module 40, an integration processing module 50, an image module 60, a product module 70, an edit module 80, and a photograph module 90.

The interface module 10 is electrically connected with the terminal machine, and allowed to be a displaying monitor. The interface module 10 is applied for texts or images displaying.

The store information module 20 is signally connected with the interface module 10. The store information module 20 is disposed at a remote server and signally connected with the terminal machine of the user. In an embodiment of the present invention, the remote server is connected with the terminal through the internet. The store information module 20 is provided with a plurality of store information 21. In an embodiment of the present invention, the store information module 20 gathers the newest information of existing stores from all regions of the city, and uploads the newest store information 21 that are saved in the store information module 20 at all times. Each of the store information 21 includes the type, name, address, capital amount, and sales volume of the store, respectively.

The requirement module 30 is signally connected with the store information module 20 and displayed at the interface module 10. The requirement module 30 is disposed at the remote server and signally connected with the terminal machine used by the user. In an embodiment of the present invention, the remote server is connected with the terminal machine through the internet. The requirement module 30 provides several selectable options, including a commercial area requirement 31, a turnover requirement 32, a search range requirement 33, and a store type requirement 34. The commercial area requirement 31 provides regional information of various commercial areas in different cities that are gathered and saved. Taking Taiwan as an example, the corresponding cities include Taipei, Taoyuan, and Taichung, wherein each city further includes different county and district areas, wherein each county or district area further includes different commercial areas. For example, Xitun District of Taichung City in Taiwan includes FengChia commercial area and Tong Hai commercial area; Shilin District of Taipei City in Taiwan includes Shilin night market commercial area.

The turnover requirement 32 provides information of turnover amounts of each stores. In an embodiment of the present invention, the turnover requirement 32 provides various turnover range, namely under two million dollars per month, between two to four million dollars per month, and between four to six million dollars per month, respectively.

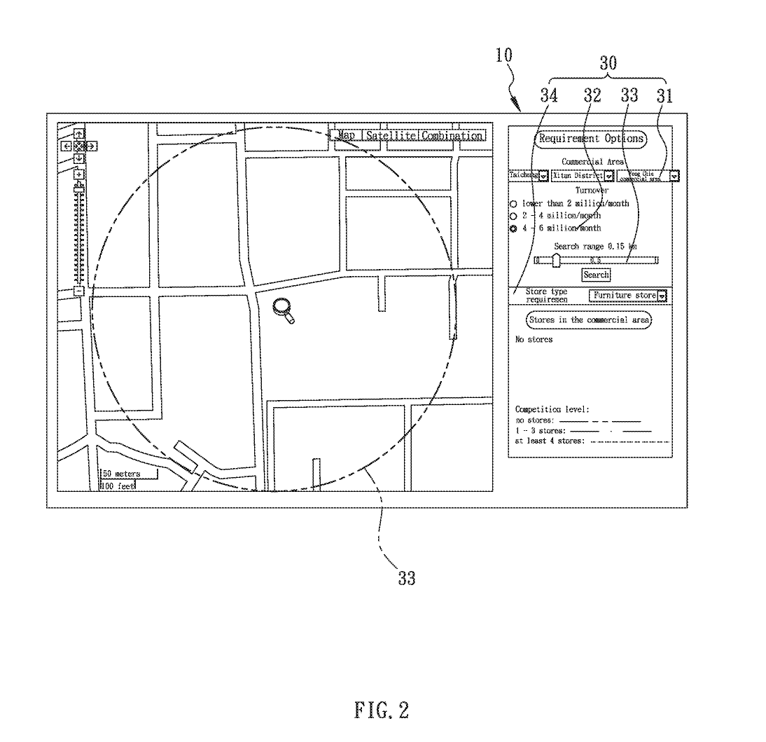

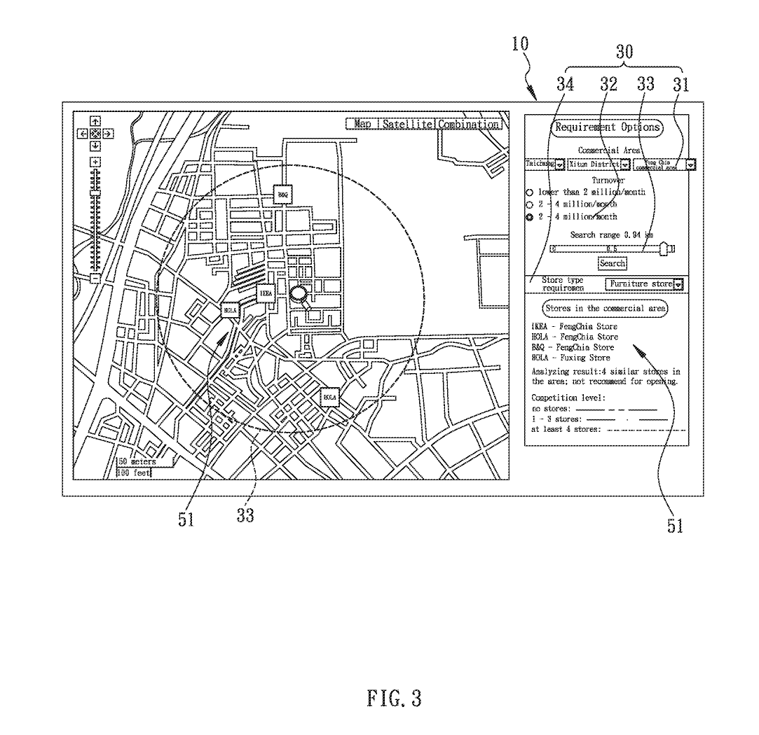

The search range requirement 33 provides different options of search range, divided with a certain radius distance around surrounding the center of each commercial area listed in the commercial area requirement 31. In an embodiment of the present invention, the radius distance unit applied to divide different commercial areas by the search range requirement 33 ranges from zero kilometer to one kilometer, as shown by FIG. 2 and FIG. 3.

The store type requirement 34 provides different selectable options representing the industry type of a store, such as a convenient store, a furniture store, or a costume and accessory store.

The operation module 40 is signally connected with the store information module 20 and the requirement module 30. The operation module 40 refers to the control element of the terminal machine. When the terminal machine is a computer, the operation module 40 is allowed to be a mouse or a keyboard of the computer. When the terminal machine is an intelligent portable device, the operation module 40 is a touch-operating system of the interface module 10. The operation module 40 is applied to select the commercial area requirement 31, the turnover requirement 32, the search range requirement 33, and the store type requirement 34 that are display at the interface module 10.

The integration processing module 50 is signally connected with the requirement module 30 and the interface module 10. The integration processing module 50 is disposed at the remote server and signally connected with the terminal machine of the user. In an embodiment of the present invention, the remote server is connected with the terminal machine through the internet. The integration processing module 50 screens each of the store information 21 in the store information module 20 based on the commercial area requirement 31, the turnover requirement 32, the search range requirement 33, and the store type requirement 34 selected by the operation module 40, so as to analyze and acquire an integration analyzing result 51, which is then displayed at the interface module 10 in a graphical form. In an embodiment of the present invention, the integration analyzing result 51 is allowed to be texts or image.

In an embodiment of the present invention, the integration processing module 50 screens the store information 21 according to the store type requirement 34 selected by the operation module 40 to acquire qualified stores. Next, the integration processing module 50 further screens the qualified stores to acquire the stores in the location corresponding to the address information according to the commercial area requirement 31 and the search range requirement 33 selected by the operation module 40. Subsequently, the integration processing module 50 compares the capital amount, sales volume, and the turnover requirement 32 of the stores according to the store names corresponding to the address. By such screening process, the integration processing module 50 selects the final store information 21 and arrange the store information 21 to acquire an integration analyzing result 51. The user (potential store owner) is able to understand the amount of similar stores, and the capital amount and sales volume of similar stores in the target commercial area, so as to acquire the basis for determining if the user will benefit from opening a store in the target commercial area.

The image module 60 is signally connected with the store information module 20, the requirement module 30, the interface module 10, and the integration processing module 50. The image module 60 is displayed at the interface module 10. The image module 60 is disposed at the remote server and signally connected with the terminal machine of the user. In an embodiment of the present invention, the remote server is connected with the terminal machine through the internet. The image module 60 is provided with a map information 61. The commercial area requirement 31 and the search range requirement 33 are corresponding to be displayed at the map information 61, wherein the store information 21 and the integration analyzing result 51 are displayed at the map information 61, with the integration analyzing result 51 having different colors to represent different competition level. In an embodiment of the present invention, the integration processing module 50 screens the store information module 20 according to the requirements selected by the operation module 40 through the requirement module 30, the store information 21 of qualified stores are acquired, such that the integration analyzing result 51 is displayed at the map information 61 in a text form, and different colors are applied to perform the competition level according to the commercial area requirement 31 and the search range requirement 33 of the requirement module 30, as shown by FIG. 1 to FIG. 3.

For example, when no competing stores exist in the commercial area under the requirements set up in the requirement module 30, a green color is presented at the map information 61. When at least one competing store exists in the commercial area under the requirements set up in the requirement module 30, a blue color is presented at the map information, and the name of the competing store is displayed at the location upon the map information 61 corresponding to the store address, with the capital amount and sales volume of the competing store displayed as well. When more than three competing stores exist in the commercial area under the requirements set up in the requirement module 30, a red color is presented at the map information, and the names of the competing stores are displayed at the locations upon the map information 61 corresponding to the store addresses, with the capital amount and sales volume of the competing stores displayed as well. By the graphical and colorful display of the integration analyzing result 51 at the map information 61, a clear competition analysis among the stores in the commercial area is acquired, providing a basis for determining if the user (potential store owner) will benefit from opening a store, as shown by FIG. 1 to FIG. 3.

The product module 70 is disposed at the remote server and signally connected with the interface module 10 and the terminal machine of the user. In an embodiment of the present invention, the remote server is connected with the terminal machine through the internet. The product module 70 stores a plurality of product signals 71 and product information 72 corresponding to each product signal 71. The product signal 71 and the product information 72 are allowed to be displayed at the interface module 10. Also, the image form of each product signal 71 is identical to the real form of the corresponding product.

The edit module 80 is signally connected with the interface module 10, the operation module 40, and the product module 70. The edit module 80 is disposed at the remote server and signally connected with the terminal machine of the user. In an embodiment of the present invention, the remote server is connected with the terminal machine through the internet. The edit module 80 adds and amends each product signal 71 and product information 72 through the operation module 40. In an embodiment of the present invention, the edit module 80 adds the product signal 71 of the target product to the product module 70, and also adds and edits a product information 72 of the corresponding product signal 71 in the product module 70. Also, the edit module 80 is allowed to amend the product signal 71 and product information 72 already saved in the product module 70.

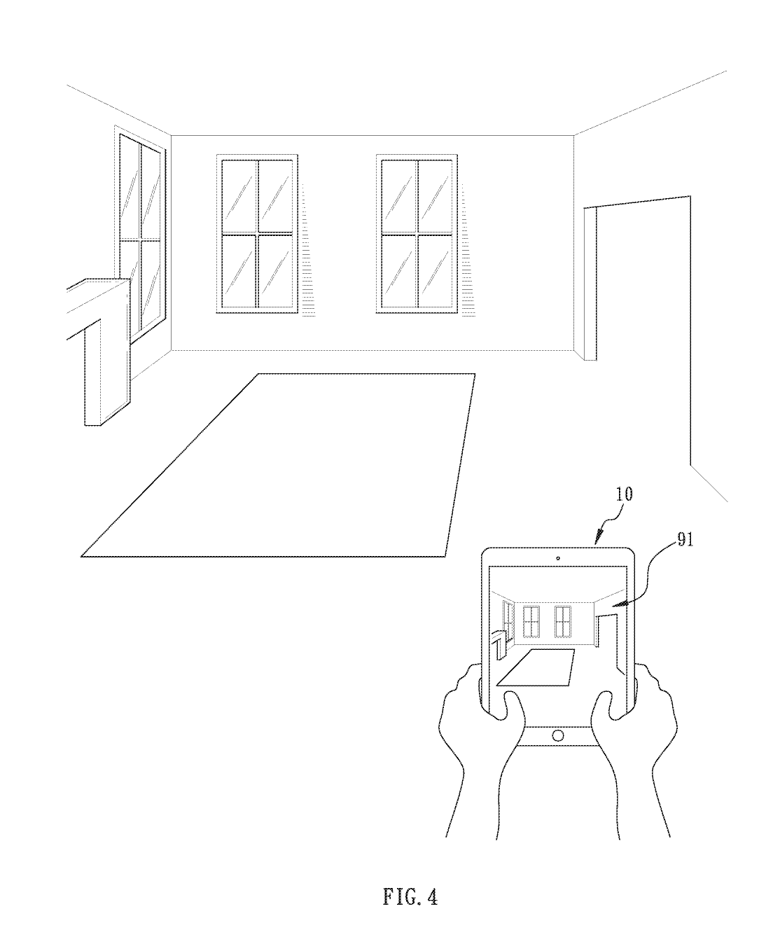

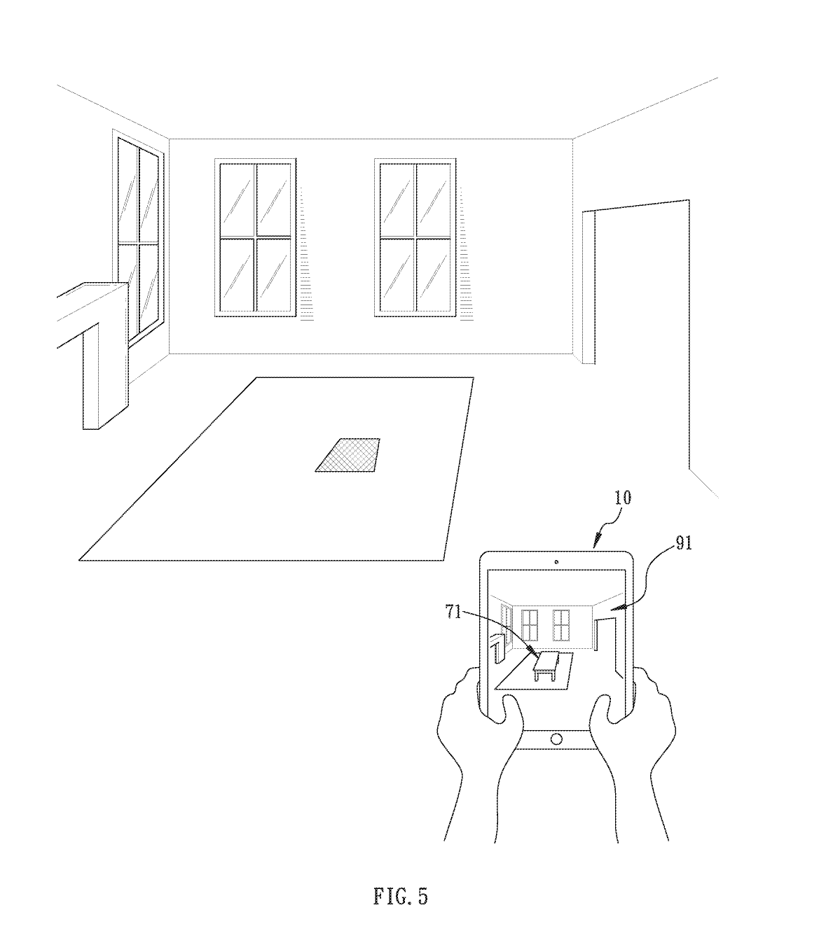

The photograph module 90 is signally connected with the interface module 10, the product module 70, the operation module 40, and the terminal machine. In an embodiment of the present invention, the photograph module 90 is a camera. The photograph module 90 is applied for photographing the real environment to produce a space image signal 91 which is to be displayed at the interface module 10. By use of the operation module 40, the product signals 71 are selected to be placed in the space image signal 91. Therefore, referring to FIG. 1, FIG. 4, and FIG. 5, the photograph module 90 photographs the real environment in which the products are to be placed, so as to produce the space image signal 91 corresponding to the real environment, which is to be displayed at the interface module 10. The interface module 10 simultaneously displays the product signals 71 of the product module 70. By clicking, sliding, or pulling, the operation module 40 is applied to select the product signals 71 that are to be placed in the space image signal 91. With such configuration, the product signals 71 are performed in a realistic status in the space image signal 91 produced according to the real environment. Therefore, the simulation of the virtual products and the real environment is provided. An information integration displaying method in accordance with an embodiment of the present invention is provided, comprising steps of requirement setting, screening and comparing, result displaying, image setting, product setting, and reference selecting.

In the requirement setting step, requirement options including the commercial area requirement 31, the turnover requirement 32, the search range requirement 33, and the store type requirement 34 are selected according to the user demand. In an embodiment of the present invention, the user (potential store owner) uses the operation module 40 to select the commercial area requirement 31, the turnover requirement 32, the search range requirement 33, and the store type requirement 34 through the requirement module 30 displayed at the interface module 10, as shown by FIG. 1 and FIG. 2.

In the screening and comparing step, the store information 21 are screened according to the selected commercial area requirement 31, turnover requirement 32, search range requirement 33, and store type requirement 34, so as to carrying out the analyzing process and acquire an integration analyzing result 51. In an embodiment of the present invention, the integration processing module 50 firstly screens out the store information 21 fulfilling the store type requirement 34 in the store information module 20. Next, the integration processing module 50 screens the qualified store information 21 to acquire the store information 21 fulfilling the commercial area requirement 31 and the search range requirement 33, so as to acquire the addresses and the store names of the corresponding qualified store information 21, respectively. Next, the integration processing module 50 further screens the capital amount, the sales volume, and the turnover of such store information 21, so as to acquire the store information 21 fulfilling the turnover requirement 32, and arrange the finally qualified store information 21 into an integration analyzing result 51.

In the result displaying step, the integration analyzing result 51 is graphically displayed at the map information 61, so as to present the competition level in the search range requirement 33. In an embodiment of the present invention, the integration processing module 50 performs the screened qualified store information 21 at the map information 61 of the image module 60 through the interface module 10 in a text form, and applies different colors to perform the competition levels of similar stores in the areas corresponding to the commercial area requirement 31 and the search range requirement 33 of the requirement module 30. By graphically displaying the integration analyzing result 51 at the map information 61 with different colors, the user is able to understand the competition status among similar stores in the target commercial area, and acquire a basis for determining if the user (potential store owner) will benefit from opening the store, as shown by FIG. 1 and FIG. 3.

In the image setting step, a target location suitable for a new store is selected at the map information 61 according to the integration analyzing result 51, such that the target location is transformed into a solid store image. In an embodiment of the present invention, the integration analyzing result 51 is acquired through the aforementioned requirement setting step, screening and comparing step, and the result displaying step. Next, the integration processing module 50 collects house rental information from house rental websites, and the house rental information is saved in the integration processing module 50. When the integration processing module 50 displays applicable house rental/selling information at the interface module 10, the user (potential store owner) selects the suitable target location, and the integration processing module 50 graphically displays the solid store image at the interface module 10, wherein the solid store image is produced with photograph and conducted in the house rental information. However, the solid store image is allowed to be conducted in the integration processing module 50 in other forms, such as a building picture file.

In the product setting step, the product signals 71 and the product information 72 corresponding to each product signal 71 are disposed in the solid store image. In an embodiment of the present invention, the user (potential store owner) is able to add the product signals 71 corresponding to the target products into the product module 70 through the edit module 80, and also able to add/edit product information 72 corresponding to the product signals 71.

In the reference selecting step, a space image signal 91 is produced by photographing a real environment, in which the product signals 71 are placed. In an embodiment of the present invention, the photograph module 90 is applied for photographing the real environment in which the products are placed, so as to produce the space image signal 91 corresponding to the real environment which is then displayed at the interface module 10. Also, the interface module 10 simultaneously displays the product signals 71 of the product module 70. The operation module 40 is applied for placing the selected product signals 71 in the space image signal 91, as shown by FIG. 1, FIG. 4, and FIG. 5.

### Example

When the user wishes to open a furniture store, the user is allowed to acquire the integration analyzing result 51 through the requirement setting step, the screening and comparing step, and the result displaying step. Next, the user selects the suitable target location through the image setting step. The integration processing module 50 transforms the target location into a corresponding solid store image which is graphically displayed at the interface module 10.

The user is able to add the product signals 71 and the product information 72 corresponding to the product signals 71 of the furniture store into the product module 70 by use of the edit module 80. Next, the user arrives the realistic store location and photographs the real environment by use of the photograph module 90, thereby producing the space image signal 91 corresponding to the real environment which is displayed at the interface module 10. Meanwhile, through the interface module 10, the user is able to place the product signals 71 that are displayed at the interface module 10 in the space image signal 91 by use of the operation module 40, so as to assure that the product signals 71 conducted in the solid store image are disposed in the correct space and position of the real environment. Finally, the realistic furniture are placed at the location of the newly-opened store, thus reducing the errors between the predetermined arrangement and the real arrangement, and increasing the flexibility of arrangement.

Also, a potential consumer is allowed photograph the real environment predetermined for placing the furniture by the photograph module 90, so as to produce the space image signal 91 corresponding to the real environment to be displayed at the interface module 10. The interface module 10 simultaneously displays the product signals 71 conducted by the store owner. The potential consumer is able to place the selected product signals 71 in the space image signal 91 through the operation module 40. Therefore, through the space image signal 91 corresponding to the real environment, the potential consumer displays the product signals 71 in the real form, so as to consider if the selected furniture fulfill the consumer demand, and subsequently conduct the purchase. Therefore, the uncertainty upon the products is lowered, and a physical purchasing experience is provided

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An information displaying platform, comprising:
an interface module;
a store information module signally connected with the interface module and provided with a plurality of store information;
a requirement module signally connected with the interface module and displayed at the interface module, the requirement module providing requirement options including a commercial area requirement, a turnover requirement, a search range requirement and a store type requirement;
an operation module signally connected with the requirement module, such that a user selects option among the commercial area requirement, the turnover requirement, the search range requirement and the store type requirement through the operation module; and
an integration processing module signally connected with the store information module, the requirement module, and the interface module, the integration processing module screening the store information according to the selected options of the commercial area requirement, the turnover requirement, the search range requirement, and the store type requirement, so as to analyze to acquire an integration analyzing result which is graphically displayed at the interface module.

2. The information displaying platform of claim 1, further comprising a product module signally connected with the interface module, the product module storing a plurality of product signals and product information corresponding to each product signal, the product signals and the product information being displayed at the interface module.

3. The information displaying platform of claim 2, further comprising a photograph module signally connected with the interface module, the product module, and the operation module, the photograph module photographing a real environment to produce a space image signal which is displayed at the interface module, the operation module selecting the product signals to be placed in the space image signal.

4. The information displaying platform of claim 2, further comprising an edit module signally connected with the interface module, the operation module, and the product module, the user applying the edit module to optionally add or amend the product signals and the product information through the operation module.

5. The information displaying platform of claim 1, further comprising an image module signally connected with the store information module and the integration processing module, the image module provided with a map information, such that the store information and the integration analyzing result are graphically displayed on the map information.

6. The information displaying platform of claim 5, wherein the image module is signally connected with the requirement module and the interface module, the image module displayed at the interface module, the commercial area requirement and the search area requirement correspondingly displayed on the map information.

7. The information displaying platform of claim 5, wherein the integration analyzing result is displayed with colors, such that different colors represent different competition levels.

8. An information integration displaying method, comprising:
selecting a commercial area requirement, a turnover requirement, a search range requirement, and a store type requirement according to user demand;
screening a plurality of store information according to the selected commercial area requirement, turnover requirement, search range requirement, and store type requirement to analyze and acquire an integration analyzing result; and
graphically displaying the integration analyzing result on a map information, so as to acquire a competition level of stores within a scope corresponding to the search range requirement.

9. The information displaying method of claim 8, further comprising:
selecting a target location in the map information according to the integration analyzing result; and
transforming the target location into a solid store image, wherein a plurality of product signals and product information corresponding to each product signal are placed in the solid store image.

10. The information displaying method of claim 9, wherein a space image signal is produced by photographing a real environment, such that the product signals are placed in the space image signal.
